(19) United States
(12) Patent Application Publication
(10) Pub. No.: US 2013/0297924 A1
(43) Pub. Date: Nov. 7, 2013

(54) METHOD OF RUNNING MULTIPLE OPERATING SYSTEMS ON AN X86-BASED COMPUTER

(71) Applicant: INSYDE SOFTWARE, (US)

(72) Inventors: Matthew R. LAUE, Joshua Tree, CA (US); Kelly STEELE, Beaverton, OR (US); Kevin DAVIS, Beaverton, OR (US); Mike SU, Taipei (TW)

(21) Appl. No.: 13/855,895

(22) Filed: Apr. 3, 2013

Related U.S. Application Data
(60) Provisional application No. 61/619,734, filed on Apr. 3, 2012.

(51) Int. Cl. G06F 9/44

(52) U.S. Cl. CPC G06F 9/441
USPC 713/2

(57) ABSTRACT

Two or more distinct operating systems (OSs) are loaded simultaneously and run on an x86 computer system. Each OS is booted serially and in such a way that the OS resides in a separate memory footprint than the other OSs by partitioning the memory map. The partition of the memory map includes a low memory region, dedicated memory partitions for storing each OS, and dedicated regions for storing shadows of the low memory region and the ACPI for each OS. Switching between the two or more resident OSs is performed by sleeping the current OS and then resuming the desired OS using the shadow previously stored for the desired OS. None of the resident OSs require any modification in order to run in this fashion.

### CROSS REFERENCE TO RELATED APPLICATIONS

This application claims priority under 35 U.S.C. §119(e) to U.S. Provisional Application No. 61/619,734, filed on Apr. 3, 2012, the entire contents of which are incorporated herein by reference thereto.

### BACKGROUND OF THE INVENTION

1. Field of the Invention

Embodiments of the present invention relate generally to operating systems for x86-based computer systems and, more particularly, to running multiple operating systems on a single x86-based computer system.

2. Description of the Related Art

The use of two or more different operating systems (OSs) on a single computer system, such as a Windows-based and a Linux-based operating system (OS), is often desirable for users of computer systems. Techniques known in the art that allow multiple OSs to be run on the same computer system include emulation, virtualization, and combinations of both.

In emulation-based techniques, one OS, referred to as a guest OS, is run as an application of another OS, which is known as the host OS. A significant disadvantage of emulation-based techniques is a reduction in speed. In addition, the guest OS does not have full control of any real hardware. In a virtualization approach, the guest OS is allowed to run directly on the CPU for some period of time, but has the disadvantage of requiring hardware support.

Accordingly, there is a need in the art for a method that enables running multiple operating systems on a single computer system without the disadvantages inherent with emulation and virtualization approaches.

### SUMMARY OF THE INVENTION

One or more embodiments of the invention provide a method that allows two or more distinct operating systems to be loaded simultaneously on an x86 computer system. In one embodiment, for example, a version of Windows and Linux may be loaded and run on a single computer system. Each OS is booted serially and in such a way that the OS resides in a separate memory footprint than the other OSs by partitioning the memory map. The partition of the memory map includes a low memory region, dedicated memory partitions for storing each OS, and dedicated regions for storing shadows of the low memory region and the Advanced Configuration and Power Interface (ACPI) information for each OS. Switching between the two or more resident OSs is performed by sleeping the current OS and then resuming the desired OS using the shadow previously stored for the desired OS. None of the resident OSs require any modification in order to run in this fashion. Some embodiments can be implemented on computer systems with a basic input/output system (BIOS) firmware interface, and other embodiments can be implemented on computer systems with a unified extensible firmware interface (UEFI).

One advantage of the disclosed method is that multiple OSs can be loaded and run on a single x86-based computer without the lower performance associated with emulation. Another advantage of the disclosed method is that hardware support is not required.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a graphical representation of a memory map partition scheme, according to one embodiment of the invention.

FIG. 2 is a flow chart summarizing a method of configuring an x86-based computer system to run multiple operating systems simultaneously, according to an embodiment of the invention.

FIG. 3 is a flow chart summarizing a method of running multiple operating systems concurrently on an x86-based computer system, according to an embodiment of the invention.

FIG. 4 is a block diagram of an x86-based computer system that benefits from embodiments of the invention and can execute computer program instructions for running multiple operating systems simultaneously.

FIG. 5 is a graphical representation of a memory map partition scheme, according to one embodiment of the invention.

FIG. 6 is a flow chart summarizing a method of configuring an x86-based computer system with UEFI to run multiple operating systems simultaneously, according to an embodiment of the invention.

FIG. 7 is a flow chart summarizing a method of running multiple operating systems simultaneously on an x86-based computer system without S3 resume and/or an SMI interrupt, according to an embodiment of the invention.

For clarity, identical reference numbers have been used, where applicable, to designate identical elements that are common between figures. It is contemplated that features of one embodiment may be incorporated in other embodiments without further recitation.

### DETAILED DESCRIPTION

According to embodiments of the invention, the primary components of the invention include a boot up component, referred to herein as the pre-kernel, a resident component, referred to herein as the SYS code, and an enhanced operating system (OS) loader.

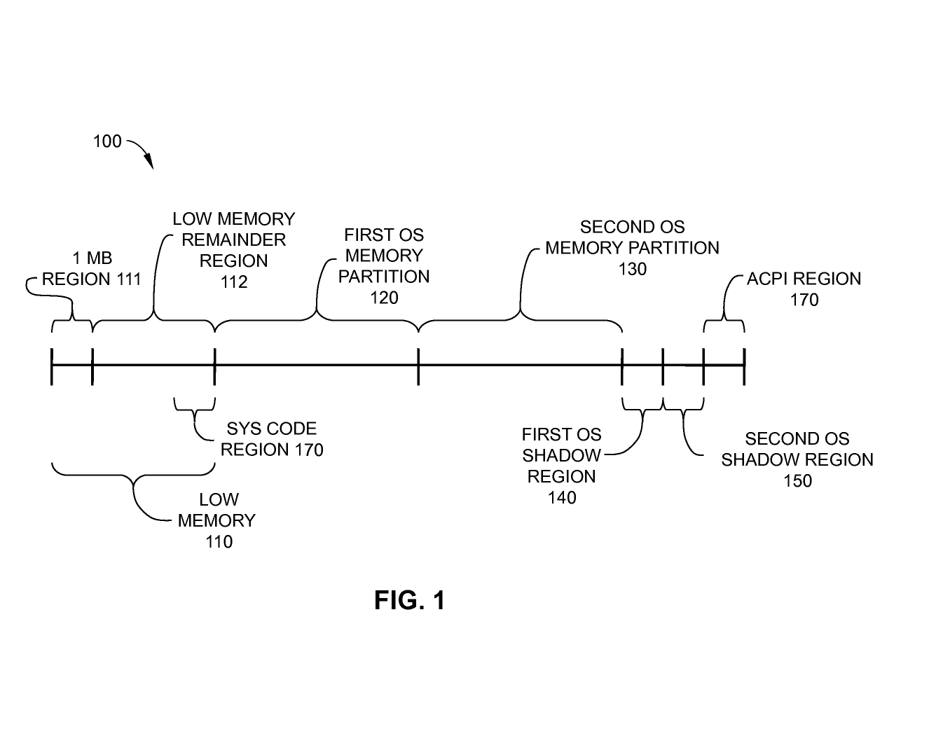

The pre-kernel is responsible for specifying the memory map according to a partitioning scheme that enables multiple OSs to exist in memory without modifications to any of the OSs. The pre-kernel also provides for a location to store the SYS code. Such a memory partitioning scheme is described below in conjunction with FIG. 1. In addition, the pre-kernel is responsible for loading the SYS code, which includes the resume hook, loading one or more of the operating systems and OS loaders, and booting the first OS. After control is passed to the initial OS, the pre-kernel can be discarded and/or overwritten. The pre-kernel is loaded by the boot loader and runs before any OS kernels, and can be implemented in any format compatible with the boot loader. There are no other requirements on the boot loader. In one embodiment, the pre-kernel is a multi-boot kernel loaded by the Grand Unified Boot Loader (GRUB).

The SYS code is the resident component of the application and must remain in memory in order to handle the actual switching between the multiple OSs. The primary functions of the SYS code include the memory partition handler and the resume hook, both of which are described below. Different memory partition handlers may be used in different embodiments, depending on the BIOS implemented with a particular computer system. For example, in one embodiment, in which an x86-based computer system is configured with traditional BIOS, the memory partition handler is an INT15 handler. For ease of description, the memory partition handler is described below as an INT15 handler in an exemplary embodiment. However, one of skill in the art, upon reading the disclosure herein, can readily implement embodiments of the invention for an x86-based computer system configured with a different BIOS, such as an extensible firmware interface (EFI) BIOS.

The memory partition handler, referred to in this exemplary embodiment as the INT15 handler, is responsible for providing a memory map to each OS while the OS boots, an example of which is described below in conjunction with FIG. 1. To provide each OS with the requisite memory map, the INT15 handler overrides the INT15 ax=E820 function of the system firmware. This sub-function is how an x86-based OS determines the hardware memory layout when an x86-based computer system is configured with a traditional BIOS. The INT15 ax=E820 must be called in real-mode and is only called during system boot by modern operating systems. In one embodiment, the INT15 handler returns the E820 map for the current OS that was built by the pre-kernel. All other INT15 sub-functions are passed to the system firmware INT15 handler.

The resume hook is a subroutine that is called during the S3 resume path. It is responsible for fixing up the memory layout, determining which OS needs to be run next and then jumping to the OS waking vector. Embodiments of the invention contemplate a number of ways in which the SYS code inserts itself into the resume path, i.e., loads the resume hook. According to one embodiment, the resume hook is loaded by overwriting a portion of the firmware code in the BIOS shadow located in DRAM, which is typically in the physical address range 0xE0000-0xFFFFF. Such an embodiment may be used when BIOS shadow is used on resume, can be performed entirely by the pre-kernel, and does not require any modification to system firmware. According to another embodiment, the resume hook is loaded by overwriting the VGA BIOS initialization routine located at physical address 0xc0003. Such an embodiment can be used when the system calls the VGA BIOS on resume, and which can be performed entirely by the pre-kernel, and does not require any modification to system firmware. In another embodiment, the resume hook is loaded by modifying the resume code in the NVS region. Such an embodiment can be used when there is code in the NVS partition that is in the resume path. In yet another embodiment, the resume hook is loaded by modifying system firmware to specifically call the resume vector.

The enhanced OS loader is responsible for starting a particular OS for the first time. This is done in the same manner as a typical boot loader would with the added detail that some hardware must be reinitialized. When the system firmware returns control to the OS on S3 resume, the hardware is typically not in the same state as it would be after a normal POST. The OS loader is responsible for repairing such differences. Examples of differences that may occur on some platforms include initialization of the system timer and setup of the programmable interrupt controller (PIC).

Defining and acting upon the memory map is the main responsibility of the invention. In one embodiment, the user specifies the amount of system memory that each OS is allocated. The typical implementation allows this to be specified on the multi-boot command line. Because the memory map for a x86-based operation system is determined and fixed at boot time, returning the partitioned memory map for the current OS via the INT15 ax=E820 function is mostly sufficient, except for the 0-1 MB RAM region, the remainder of low memory, and the ACPI regions.

Most modern operating systems, including current Windows and Linux, refuse to boot if memory is not available in both the <1 MB RAM region or in the remainder of low memory. The remainder of low memory is the memory starting at 1 MB, and is defined below in conjunction with FIG. 1. As such, there must be E820 entries in each of these regions present in all OS memory maps. To prevent conflicts, i.e., multiple OSs writing to the same memory, embodiments of the invention create shadows of these regions in high memory. When the OS is changed, the contents of these regions are saved to their respective shadows for the current OS and restored for the new OS. In one embodiment, such memory shadowing is implemented for all system memory less than 16 MB, since system memory of 16 MB is sufficient for Windows- and Linux-based operating systems. However, shadowing system memory greater than 16 MB is also contemplated by embodiments of the invention, since the upper bound of the low memory region is implementation dependent.

Similarly, any ACPI regions present on the system must also be shadowed in the same fashion. The ACPI tables found in this region are pointed to by physical address and therefore cannot be moved without modification to the RSDP table and/or NVS regions. Furthermore, the ACPI specification permits the ACPI memory regions to be recycled by the OS. Thus, any ACPI regions present on the system must also be shadowed in order to avoid potentially losing OS-specific data. It can be appreciated that ACPI NVS regions are not—and cannot be—relocated since they contain the FACS table, which in turn contains the ACPI global lock.

FIG. 1 is a graphical representation of a memory map partition scheme 100, according to one embodiment of the invention. Memory map partition scheme 100 is specified by the pre-kernel. As an illustrative example, memory map partition scheme 100 is configured to accommodate a Windows and a Linux OS. One of skill in the art will appreciate that more than two operating systems can be accommodated in a similar fashion, according to embodiments of the invention. Similarly, the operating systems than can benefit from the present invention are not limited to Windows- and Linux-based operating systems.

Memory map partition scheme 100 includes a low memory region 110, a first OS memory partition 120, a second OS memory partition 130, a dedicated memory region, and an ACPI region 170. The dedicated memory region is made up of the different memory regions reserved for use by the code that performs embodiments of the invention, and includes a first OS shadow region 140, a second OS shadow region 150, and a SYS code region 160. As shown, the low memory region 110 includes a first megabyte region 111 and a low memory remainder region 112. First megabyte region 111 includes the 0-1 MB RAM required to be set aside for most modern operating systems. Low memory remainder region 112 includes the memory region starting at 1 MB and extending to an upper bound that depends on the particular embodiment, where a typical value for such an upper bound may be in the 16-128 MB range. It is contemplated that low memory remainder region 112 is not limited in size and may extend beyond 16 MB when necessary for proper operation of a particular OS. First OS memory partition 120 is the memory partition for the first OS, e.g., a Windows-based OS, may be on the order of a few MBs to multiple GBs in size, and is seen as a reserved region, i.e., a do not use region, by the second OS. Second OS memory partition 130 is the memory partition for the second OS, e.g., a Linux-based OS, may be on the order of a few MBs to multiple GBs in size, and is seen as a do not use region by the first OS. First OS shadow region 140 is sized by the pre-kernel to accommodate a shadow of the low memory region 110 and the requisite ACPI regions of the first OS. Second OS shadow region 150 is sized by the pre-kernel to accommodate a shadow of the low memory region 110 and the requisite ACPI regions of the second OS. First OS shadow region 140 and second OS shadow region are both seen as do not use regions of memory by both the first and second OS. SYS code region 160 is sized by the pre-kernel to accommodate the SYS code, and is seen by each OS as a do not use region of memory. In FIG. 1, the location of SYS code region 160 is depicted inside of first megabyte region 111. One of skill in the art will appreciate that in embodiments of the invention directed to an x86-based computer system configured with a traditional BIOS, it may be required to include SYS code region 160 in first megabyte region 111, since the SYS code in such an embodiment may include 16 bit code, such as the INT15 handler. More generally, embodiments of the invention contemplate SYS code region 160 being located anywhere in memory map partition scheme 100 that is unreserved. The term “unreserved,” as defined herein, refers to portions of the memory partition for a particular OS that is not labeled as “Reserved,” as per the ACPI specification.

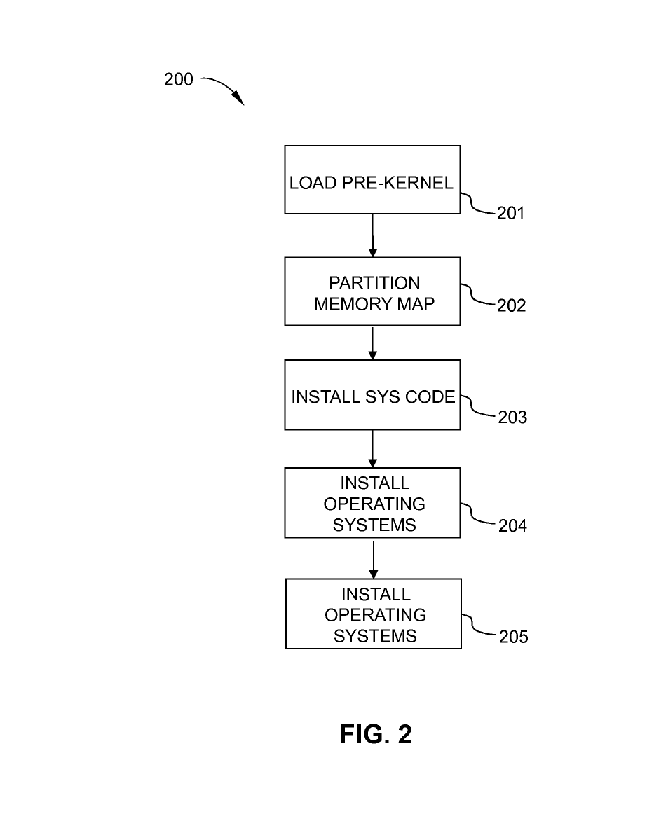

FIG. 2 is a flow chart summarizing a method 200 of configuring an x86-based computer system to run multiple operating systems simultaneously, according to an embodiment of the invention. For ease of description, method 200 is described in terms of configuring a system for two operating systems and using a memory map partition substantially similar to memory map partition scheme 100 in FIG. 1. However, configuring a system with more than two OSs and/or using other partition schemes is also contemplated.

In step 201, the pre-kernel is loaded by the boot loader.

In step 202, the pre-kernel partitions the memory map for the system with a low memory region 110, a first OS memory partition 120, a second OS memory partition 130, a first OS shadow region 140, a second OS shadow region 150, a SYS code region 160, and an ACPI region 170. In one embodiment, SYS code region 160 may be located in a portion of the low memory region 110.

In step 203, the pre-kernel loads the SYS code in SYS code region 160 of memory.

In step 204, the pre-kernel loads the two operating systems. In one embodiment, the pre-kernel loads the first OS entirely and the second OS entirely. In another embodiment, the pre-kernel loads the first OS entirely and then loads an OS loader capable of loading the second OS. In such an embodiment, the second OS may be loaded at any time after the first OS is loaded.

In step 205, the pre-kernel boots up the first OS and the x86-based computer system begins normal operation.

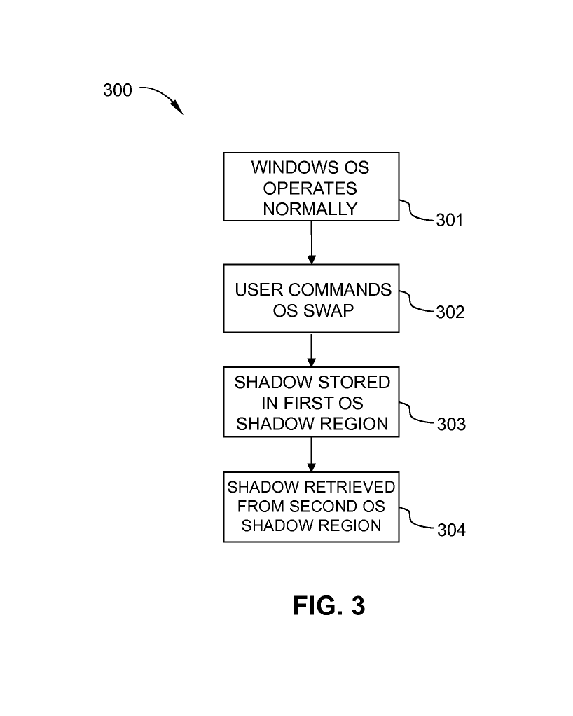

FIG. 3 is a flow chart summarizing a method 300 of running multiple operating systems concurrently on an x86-based computer system, according to an embodiment of the invention. For ease of description, method 300 is described in terms of running two operating systems: a Windows-based OS and a Linux-based OS. In accordance with an exemplary embodiment, a memory map partition substantially similar to memory map partition scheme 100 in FIG. 1 is assumed. However, it can be appreciated that running more than two OSs and/or using other partition schemes is also contemplated.

In step 301, the Windows OS resides in first OS memory partition 120 and low memory region 110, and is operating normally. A Linux OS resides in second OS memory partition 130 with the remainder of the memory image saved in second OS shadow region 150. In accordance with an embodiment, a low memory remainder region 112 for the Linux OS is stored in a second OS shadow region 150. In addition, the ACPI regions of the Linux OS are stored in second OS shadow region 150. The SYS code resides in SYS code region 160 as loaded by the pre-kernel.

In step 302, a user requests an OS swap from Windows to Linux, i.e., Windows is changed to sleep mode and Linux is resumed.

In step 303, the SYS code inserts itself into the resume path. As noted above, this can be accomplished by a number of methods, including overwriting a portion of the firmware code in the BIOS shadow located in DRAM, overwriting the VGA BIOS initialization routine, modifying the resume code in the NVS region, and modifying system firmware to specifically call the SYS code during the resume path. The SYS code then stores a shadow of the Windows OS memory currently residing in low memory region 110, and ACPI region 170 into first OS shadow region 140. In one embodiment, information located in low memory region 110 that is dedicated to BIOS, e.g., the VGA BIOS, is not included in the shadow of the Windows OS stored in first OS shadow region 140.

In step 304, the SYS code commands that the shadow stored in second OS shadow region 150, which includes a shadow of low memory region 110 for the Linux OS and the ACPI regions of the Linux OS, be placed in low memory region 110. In this way, the Linux OS is able to resume in the same configuration as when the Linux OS was last active.

In step 305, after the state of the Windows OS is saved and the Linux OS state is restored, the system then jumps to the Linux resume vector, which starts the resume process for the Linux OS. The Linux then resumes as normal.

Using a similar procedure, the Linux OS can be swapped with the Windows OS and Windows can be resumed in the same configuration as when Windows was last active. One of skill in the art will appreciate that method 300 allows an x86-based computer system to run multiple operating systems with full access to hardware by either OS, and that such a solution is currently unknown in the art.

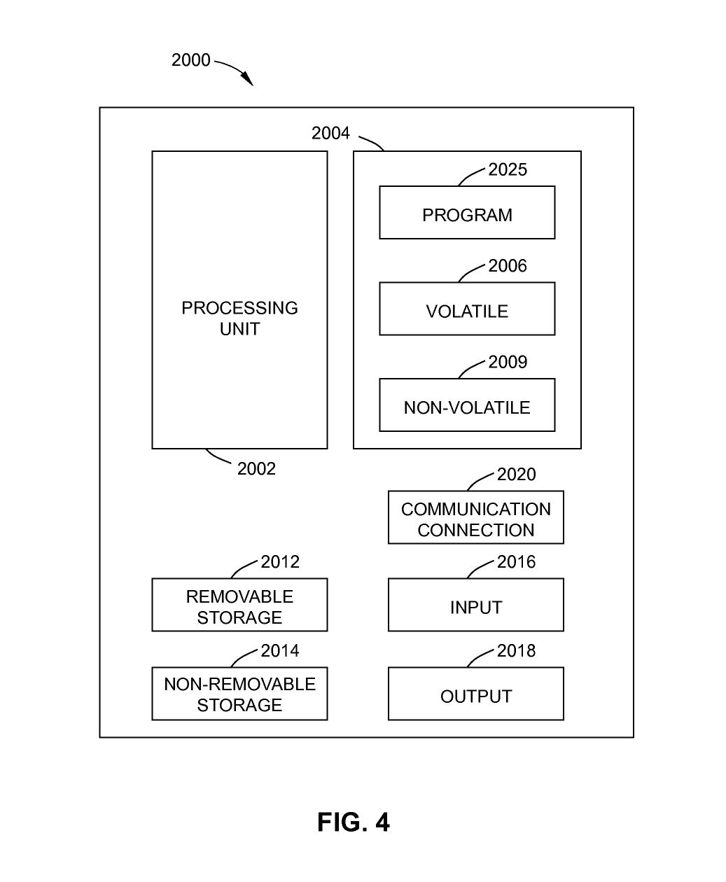

FIG. 4 is a block diagram of an x86-based computer system 2000 that may benefit from embodiments of the invention and may execute computer program instructions for running multiple operating systems simultaneously. Computer system 2000 includes a processing unit 2002, memory 2004, removable storage 2012, and non-removable storage 2014. Memory 2004 may include volatile memory 2006 and non-volatile memory 2008, either of which may contain some or all of memory map partition scheme 100. Computer system 2000 may include, or have access to a computing environment that includes, a variety of computer-readable media, such as volatile memory 2006 and non-volatile memory 2008, removable storage 2012 and non-removable storage 2014. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer system 2000 may include or have access to a computing environment that includes input 2016, output 2018, and a communication connection 2020. One of the inputs could be a keyboard, a mouse, or other selection device. The communication connection 2020 can also include a graphical user interface, such as a display. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executed by the processing unit 2002 of the computer system 2000. A hard drive, CD-ROM, and RAM are some examples of articles including a computer-readable medium. For example, a computer program 2025 capable of providing a generic technique for configuring an x86-based computer system to run multiple operating systems simultaneously and/or for running multiple operating systems simultaneously may be included on a CD-ROM and loaded from the CD-ROM to a hard drive. The computer-readable instructions allow computer system 2000 to provide generic access controls in a COM based computer network system having multiple users and servers.

A machine-readable medium, such as discussed above, provides instructions that, when executed by an x86-based computer system, cause the computer system to load a pre-kernel application, partition the memory map for the computer system to include a low memory region, a first OS memory partition, a second OS memory partition, a first OS shadow region, a second OS shadow region, and a resident component region, load a resident component in the resident component region of the system, load multiple operating systems on the system, and boot up the first OS. Alternatively, a machine-readable medium provides instructions that, when executed by an x86-based computer system, cause the computer system to store in a shadow region a shadow of the contents of a low memory region and the ACPI regions of the current OS, retrieve a shadow of a low memory region and the ACPI regions of a second OS, and resume the second OS.

The embodiments described above in conjunction with FIGS. 1-4 are generally applicable to loading multiple operating systems simultaneously on an x86 computer system configured with a basic input/output system (BIOS) firmware interface. In other embodiments, two or more distinct operating systems can be loaded simultaneously on an x86 computer system configured with a unified extensible firmware interface (UEFI). In such embodiments, the UEFI for a computer system is modified appropriately to perform operations performed by the SYS code in embodiments described above.

In such embodiments, the UEFI defines a memory map substantially similar to memory map partition scheme 100 in FIG. 1, including low memory region 110, first OS memory partition 120, second OS memory partition 130, and the dedicated memory region. The UEFI-defined memory map is generally used in the same way that memory map partition scheme 100 is used by the SYS code so that multiple OSs can be simultaneously loaded on a single computer system and operation thereof switched between said OSs. Thus, the UEFI defines a memory partition for each OS to be loaded on the computer system and, because some of the low memory of the computer system is shared between OSs, the UEFI also defines shadow regions for each OS to be loaded on the computer system. It is noted that in embodiments directed to a computer system configured with UEFI, ACPI region 170 is not required in memory map partition scheme 100. However, some portions of the low memory used by the UEFI do have to be shadowed to prevent conflicts when switching between OSs. Generally, only a few scattered portions of UEFI memory require such shadowing. These portions of UEFI memory can each be stored in a separate shadow location or compressed into a single shadow location, as desired.

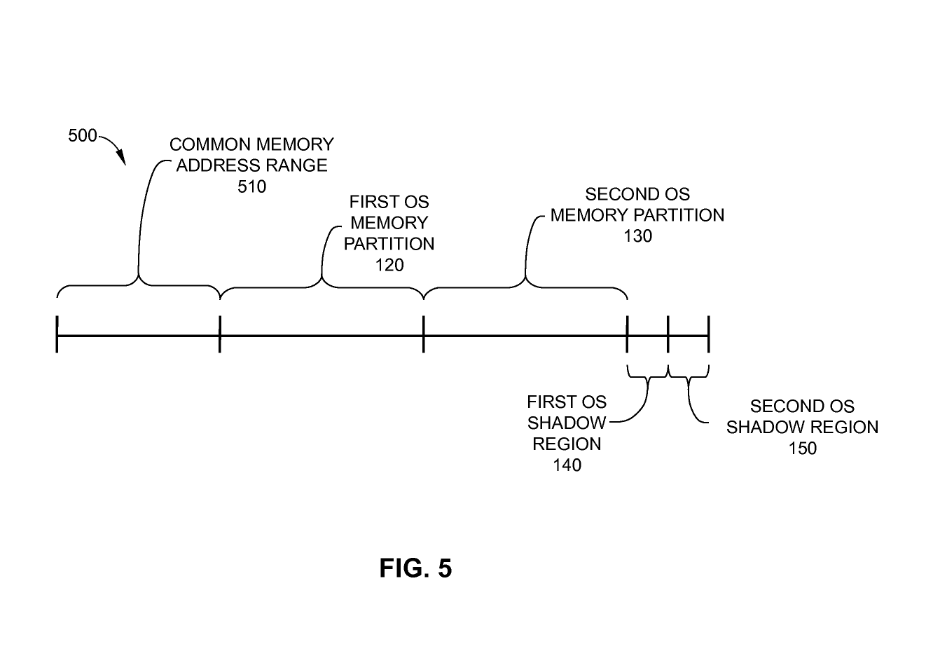

FIG. 5 is a graphical representation of a memory map partition scheme 500, according to one embodiment of the invention. Memory map partition scheme 500 is specified by UEFI, and in an illustrative example is configured to accommodate two OSs. One of skill in the art will appreciate that more than two operating systems can be accommodated in a similar fashion, according to embodiments of the invention.

Memory map partition scheme 500 includes first OS memory partition 120, second OS memory partition 130, first OS shadow region 140, and second OS shadow region 150, which are described above in conjunction with FIG. 1. In addition, memory map partition scheme 500 includes a common memory address range 510, which comprises a range of memory that both a first OS and a second OS assume is present and available for use. Data stored in the common memory address range 510 when the first OS is active is saved in first shadow region 140 when switching from the first OS to the second OS. Likewise, data stored in the common memory address range 510 when the second OS is active is saved in second shadow region 150 when switching from the second OS to the first OS. Such data includes extended boot services, which are described below, and portions of UEFI code that are shadowed to prevent conflicts when switching between OSs.

To facilitate booting the additional OSs, i.e., a second OS, a third OS, etc., some portions of the UEFI that are conventionally designated as boot services are instead designated as “extended boot services,” and are treated as run-time services. Consequently, these “extended boot services” are not overwritten or discarded after booting up the first OS, and are instead retained. In this way, subsequent OSs can be booting normally using the extended boot services portion of the UEFI code. It is noted that such extended boot services make up one portion of the UEFI code that is shadowed when switching from one OS to another OS, according to embodiments of the invention.

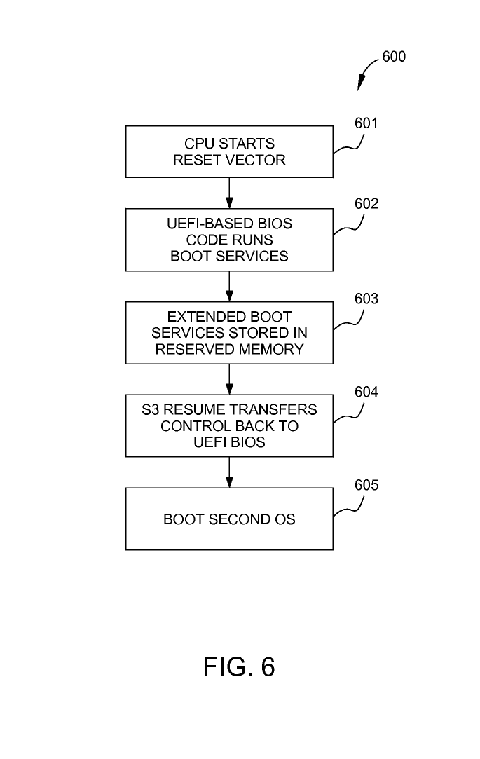

FIG. 6 is a flow chart summarizing a method 600 of configuring an x86-based computer system with UEFI to run multiple operating systems simultaneously, according to an embodiment of the invention.

In step 601, a computer system CPU starts a reset vector, which jumps to the UEFI-based BIOS code that has been modified according to embodiments of the invention.

In step 602, the UEFI-based BIOS code runs through the typical boot services for booting a first OS.

In step 603, an extended boot services portion of the UEFI-based BIOS code is retained in a reserved memory portion of the physical memory of the computer system, rather than being deleted, stored in a region of physical memory that can be overwritten by an OS, or otherwise discarded. The reserved memory portion used to store the extended boot services is a portion of the physical memory of the computer system that is designated by the UEFI code as unavailable for use by any OS. Thus, boot services for booting subsequent OSs are retained as run-time services and are still available after the end of the boot process for the first OS.

In step 604, S3 resume is used to transfer control back to UEFI BIOS.

In step 605, a second OS is booted using the extended boot services stored in reserved memory in step 603.

Embodiments of the invention described above are generally applicable to loading multiple OSs simultaneously on an x86 computer system and then transitioning between said OSs using the S3 sleep state. However, some processors may not include such a feature. It is noted that without an S3 sleep state, computer system BIOS does not participate in the sleep state transition, and therefore cannot be used to perform the switching between multiple OSs as described above.

Some embodiments of the invention facilitate loading two or more distinct operating systems simultaneously on an x86 computer system with a processor that does not have an S3 sleep state and/or an SMI interrupt. In such embodiments, the SYS code or the UEFI BIOS are modified with respect to previously described embodiments. As in previous embodiments, the SYS code or the UEFI is responsible for memory management, i.e., partitioning for multiple OSs and corresponding shadow regions. Such memory partitioning may be substantially similar to that outlined above and may vary depending on whether the computer system is configured with legacy BIOS or UEFI. In addition, however, device sharing and execution of the control logic responsible for switching from one OS to another OS is also performed by the SYS code or the UEFI.

Device sharing ensures that when switching to a particular OS, all system hardware in the computer system is in a manageable state. For example, when switching from a first OS to a second OS, the hardware should be in the same state as when the second OS was last active, i.e., when control was switched to the first OS. Alternatively, the OS may be configured to take the correct measures in order to re-enable each device to such a state. In this way, capital S3 sleep/resume is not needed in order to reinitialize each device to this previous state.

In some embodiments, hardware may be reinitialized explicitly, although in such embodiments, significant platform dependencies may be introduced.

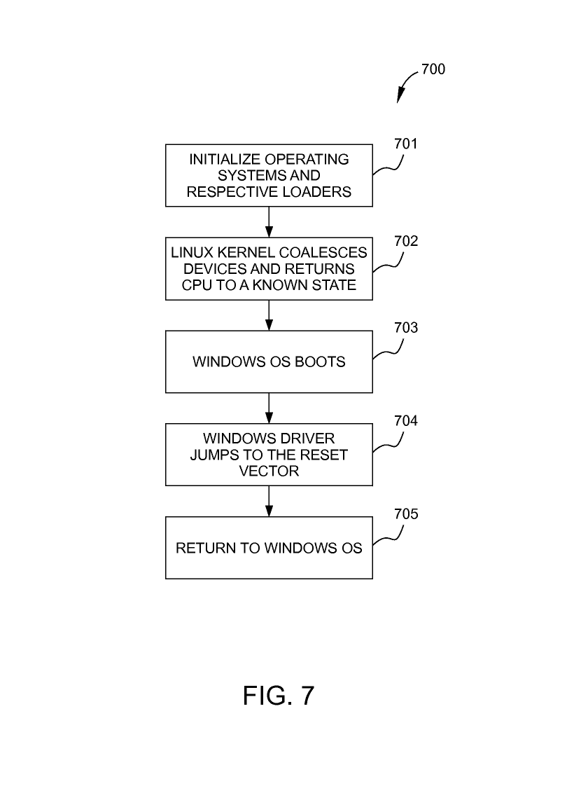

In previously described embodiments, a BIOS component of the S3 resume is used to switch from one OS to another OS loaded on the computer system. Furthermore, a system management interrupt (SMI) that is generated when an active OS writes to the power management control register is used to jump to the resume path of the inactive OS. Such an SMI provides the control logic that allows the code boot application to execute, and thereby switch from one OS to another OS. An embodiment of the invention is described below in conjunction with FIG. 7 that allows two OSs to be loaded simultaneously on a single computer system with a processor that does not have an S3 sleep state and/or an SMI interrupt.

FIG. 7 is a flow chart summarizing a method 700 of running multiple operating systems simultaneously on an x86-based computer system without S3 resume and/or an SMI interrupt, according to an embodiment of the invention. For ease of description, method 700 is described in terms of running two operating systems: a Windows-based OS and a Linux-based OS. However, it can be appreciated that running more than two OSs and/or different OSs than those described in method 700 does not exceed the scope of the invention.

In step 701, on system startup, the two or more OSs (e.g., one Linux-based and one Windows-based) and respective loaders for said OSs are initialized in the same fashion as described above.

In step 702, the Linux kernel is modified so that on the first transition from the Linux-based OS to the Windows-based OS, the Linux kernel coalesces all the devices and returns the CPU of the computer system into a known state, then performs a switch from the Linux-based OS to the Windows-based OS.

In step 703, the Windows OS boots as normal.

In step 704, a custom Windows driver jumps to the reset vector when the Windows OS is in a known state, for example at the end of the S0i3 transition. The reset vector returns execution to the system BIOS, where it is detected that this is “fake S3” and a special branch is taken that actually performs the switch.

In step 705, returning to the Windows-based OS is done by jumping to the instruction after the reset vector is touched.

In some embodiments of the invention, security measures may be implemented in an environment in which multiple OSs have been loaded on a single x86-based computer system. Such security measures can prevent a running OS from seeing the memory of another, inactive OS. Otherwise, if a user in one OS has the ability to load a kernel driver, the user could, with sufficient system knowledge, access the memory area reserved for the inactive OS. Such security is important because all modern OSs typically keep certain secret information in memory as plain text. Such practice is generally not problematic since an OS controls access to all system RAM, but when using simultaneous operating systems, this is no longer true.

In some embodiments, software-based security measures are used to address this concern, and in other embodiments hardware-based measures are used. These software- and hardware-based security measures provide varying levels of protection against the above-described unwanted access and are described below.

Software-based security embodiments generally comprise permuting or otherwise reversibly altering some or all of the physical memory for an OS in some fashion each time the OS becomes inactive due to switching by a user. There is a range of possible techniques that may be employed to permute memory in such embodiments, where each such technique linearly changes desired bytes of memory stored in physical memory in a reversible fashion. The choice of method is a trade-off between level of security and time required to switch between operating systems.

For example, in one embodiment, an XOR function with a known, but secret, value can be used. In this way, by simply XORing each 64 bits of memory with such a known value, the bits of a desired portion of memory associated with an inactive OS can be suitably altered to be unreadable by another OS. Notably, such an XOR operation can be performed relatively quickly, and therefore minimize the time required to switch from one OS to another OS. However, such an approach by itself is generally less secure than other approaches, since knowledge or determination of the secret value provides access to the physical memory of an inactive OS. In another exemplary embodiment, encryption may be used to fully encrypt some or all memory using a symmetric private key. Such an encryption scheme is very secure, but requires more time and computing resources to implement.

In other embodiments, a combination of approaches is used to reversibly alter some or all portions of the physical memory of an inactive OS. For example, portions of physical memory that store more strategic or sensitive information associated with the inactive OS, such as passwords, etc., may be fully encrypted, while other portions of the physical memory are left unchanged, undergo a relatively simple alteration, such as the XOR operation, or are only partially encrypted. In this way, security is maximized without requiring undesirably long switching time between OSs.

In the afore-mentioned embodiments that include software-based security methods, secret data is relied upon, such as an encryption key or the XOR value. As stated, knowledge of said secret data can compromise the security of physical memory of an inactive OS. Consequently, in some embodiments, such secret data is stored in a way that is hidden from any of the OSs simultaneously loaded on a computer system. For example, one such place to hide secret data is in the system RAM that is accessibly only from an SMI interrupt.

In some embodiments, all or most portions of the physical memory associated with an OS is permuted as described above. In other embodiments, only portions of the inactive OS physical memory is permuted. For example, when knowledge is available of what portions of the physical memory are associated with sensitive OS data, such as passwords, only those portions of the physical memory may be encrypted or permuted in some way. In such an embodiment, other portions of the physical memory are either left unchanged or are altered in a less secure but less time-consuming fashion.

Embodiments of the invention also include hardware-based security measures to protect the physical memory of an inactive OS. In such embodiments, such physical memory is “covered” by an otherwise available system device, which prevents an active OS from being able to expose that area of memory. For example, a PCI bridge can be configured with the desired address range, i.e., the address range corresponding to the physical memory of an inactive OS. This prevents the configuration port from being written using an SMI interrupt. The hardware treats the inactive OS memory as PCI space, so I/O targeted at that address range is intercepted by the PCI bridge, thereby preventing the underlying memory from being accessed. Similar to the software-based security measures detailed above, in some embodiments, such a hard-based security solution may only be applied to specific portions of the physical memory of an inactive OS, rather than to most or all of the physical memory of the inactive OS.

While the foregoing is directed to embodiments of the present invention, other and further embodiments of the invention may be devised without departing from the basic scope thereof, and the scope thereof is determined by the claims that follow.

What is claimed is:

1. On an x86-based computer system, a method of running multiple operating systems comprising:
starting a reset vector that jumps to a UEFI-based BIOS code;
performing boot services to boot up a first operating system (OS);
storing an extended boot services portion of the UEFI-based BIOS code in a reserved memory portion of the physical memory of the x86-based computer system;
returning control from an S3 resume operation to the UEFI-based BIOS code; and
booting a second OS using the extended boot services portion of the UEFI-based code stored in the reserved memory portion.
